(19) United States
(12) Patent Application Publication
(10) Pub. No.: US 2025/0033126 A1
(43) Pub. Date: Jan. 30, 2025

(54) RETRACTABLE DRILL BIT

(71) Applicant: Mueller International, LLC, Atlanta, GA (US)

(72) Inventors: David Latimore Hughes, JR., Signal Mountain, TN (US); Timothy J. Mitchell, Hixson, TN (US)

(21) Appl. No.: 18/226,650

(22) Filed: Jul. 26, 2023

(51) Int. Cl. B23B 51/04

(52) U.S. Cl. CPC B23B 51/0426; B23B 51/0473; B23B 2251/60

(57) ABSTRACT

A retractable pilot bit comprises a stem defining a rotational axis and configured to rotate in a first rotational direction about the rotational axis, a collar coupled to the stem and configured to rotate in the first rotational direction, and a bit configured to rotate in a first rotational direction in a penetrating configuration and configured to rotate in a second rotational direction opposite the first rotational direction in a rotatable configuration.

### TECHNICAL FIELD

This disclosure relates to pipe coupon extraction. More specifically, this disclosure relates to a pipe coupon extraction tool with a retractable pilot drill bit.

### BACKGROUND

A fluid pipe system transports a working fluid such as natural gas, petroleum, or water through piping systems and conducts the working fluid through a pipe. Pipe maintenance can involve installing stopping applications and/or valves within the charged fluid pipe system. Typical gas/water lines can be buried in the ground and can facilitate fluid distribution for a large geographical area, such as a municipal water and natural gas supply system. At times, it is necessary to cut the charged line to provide a valve or stopping application to reroute and/or service the pipe.

Installing a valve in a charged and pressurized line is typically performed with an extraction tool that resembles a hole saw that enters an enclosed cavity attached to and surrounding the pipe section to be cut. The hole saw includes a shell cutter that at least partially surrounds a pilot drill centrally located within the shell cutter. The pilot drill bit holds and orients the shell cutter of the coupon extraction tool and facilitates starting the cutting process. First, the pilot drill bit can reduce the surface area of the outer pipe that needs to be penetrated on the initial cut. Second, the pilot drill bit can direct and orient the outer shell cutter once the pilot drill penetrates the initial pipe layer. The pilot drill bit can ensure that the bit is oriented correctly relative to the pipe by directing the shell cutter through the pipe and creating a central pilot hole that reduces or prevents crack formations in the pipe or the coupon. Cutting and removing the pipe coupon from a water system is typically performed on cast iron pipe, often encased in concrete. Natural gas applications typically use copper pipes.

In a typical stopping application or valve installation on a municipal gas/water line, the cutting and/or removal of the coupon can be performed on a charged and/or pressurized line, i.e., with a pressurized working fluid within the pipe. The ability to cut and/or remove the coupon from the pipe to install the valve can reduce the number of out-of-service customers affected in the municipal service area.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a retractable pilot bit comprising: a stem defining a rotational axis and configured to rotate in a first rotational direction about the rotational axis, a collar coupled to the stem and configured to rotate in the first rotational direction, and a bit, configured to rotate in a first rotational direction in a penetrating configuration and configured to rotate in a second rotational direction opposite the first rotational direction in a rotatable configuration.

In a further aspect, disclosed is a rotation tool assembly comprising: a hub, a shell cutter comprising a sidewall and an endcap coupled to the hub, a pilot bit assembly comprising: a stem defining a rotational axis and configured to rotate in a first rotational direction about the rotational axis, a collar coupled to the stem and configured to rotate in the first rotational direction, and a bit, configured to rotate in a first rotational direction in a penetrating configuration and configured to rotate in a second rotational direction opposite the first rotational direction in a rotatable configuration.

In yet another aspect, disclosed is a method comprising: engaging a pilot bit on an outer wall of a pipe to guide a sidewall of a shell cutter to cut a top portion of the pipe, retracting the pilot bit prior to the pilot bit engaging an inner wall of the pipe, and cutting through the inner wall of the pipe with the sidewall of the shell cutter such that the pilot bit engages the outer wall of the pipe but does not engage the inner wall of the pipe.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a side perspective view of the extraction tool comprising a rotation tool assembly and an encasing tool assembly coupled to a pipe, in accordance with one aspect of the current disclosure.

FIG. 2 is an exploded side perspective view of the rotation tool assembly of the extraction tool shown in FIG. 1.

FIG. 3 is a top perspective view of the shell cutter in the rotation tool assembly of FIG. 2.

FIG. 4 is a side perspective view of a pilot drill bit assembly comprising a stem, a collar, and a bit.

FIG. 5 is a perspective view of the stem.

FIG. 6 is a perspective view of the collar.

FIG. 7 is a perspective view of the bit comprising a fastening assembly.

FIG. 8 is a perspective view of the pilot drill bit assembly in a first or penetrating configuration; the collar is transparent to highlight the interaction of the stem and bit.

FIG. 9 is a side perspective view of the pilot drill bit assembly of FIG. 8 in a second or displaced configuration.

FIG. 10 is a side perspective view of the pilot drill bit assembly of FIG. 8 in a third or rotatable configuration where the bit comprises an independent rotational degree of freedom from the stem and collar.

FIG. 11 is a side perspective view of the pilot drill bit assembly of FIG. 8 in a fourth or retracted configuration.

FIG. 12 is a schematic representation of the shell cutter and pilot drill bit assembly in the penetrating configuration.

FIG. 13 is a schematic representation of the shell cutter and the pilot drill bit assembly in the displaced configuration, illustrating the collar beginning axial translation.

FIG. 14 is a schematic representation of the shell cutter and pilot drill bit assembly in the rotatable configuration, where the bit comprises a rotational degree of freedom to rotate opposite the rotation of the stem and collar.

FIG. 15 is a schematic representation of the shell cutter and pilot drill bit assembly before retraction in an alignment configuration where the rotational degree of freedom is converted into an axial translational degree of freedom.

FIG. 16 is a schematic representation of the shell cutter and pilot drill bit assembly in the retracted configuration.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In some aspects, a fluid utility system carries a working fluid through a pipe. For example, a municipal water or natural gas line carries the working fluid from the distributor to the consumer through a piping system comprising pressurized fluid lines to customers in the municipality. At times, the utility can require maintenance and/or modification (e.g., tapping into an existing line to supply new customers), requiring the cutting and removing of a portion of the pressurized pipe. The aspects presented herein are applicable to any fluid system, such as water, sewer, natural gas, petroleum, etc. Specific examples may help illustrate some features of a particular fluid pipe. These examples are not intended to be limiting but rather only to provide additional information regarding some potential design features that may be available for a particular fluid system.

When cutting through a water pipe comprising cast iron encased in concrete, different material properties can affect the cut properties of the removed coupon and/or pipe. In this example, concrete is characterized by a high compressive strength relative to its tensile strength, and cast iron is relatively ductile and is characterized by comparable tensile and compressive strengths. The pilot drill first penetrates the iron on the first, or upper, side of the pipe. When the pilot drill bit encounters concrete on a second or lower side of the pipe, the increased friction can help the bit rotate relative to the stem and rotate into a retracted position. This facilitates using the pilot drill bit to create the initial cut into the pipe and orient the shell cutter relative to the pipe.

Ductile iron pipes can be lined with cement. Cutting through the pipe involves cutting the ductile iron layer and a layer of cement at the top and the bottom of the pipe. When cutting through the top of a coupon, the cement is characterized by a low tensile strength and breaks away. When cutting on the bottom, the cement is characterized by a high compressive strength, which can increase cutting forces on the cement and/or ductile iron of the pipe and can cause the pipe to break and/or split. The potential split or crack could break through the pressure boundary of the pipe inserted and installed within the valve. One aspect of the present disclosure is to prevent the coupon from breaking into chunks by controlling the crack boundary in the coupon and the pipe. Proper control of the crack boundary in the pipe prevents the crack from propagating through the pressure boundary and/or leaking in a subsequent stop application and/or valve installation. Similar considerations apply to working fluids in gaseous form. For example, a natural gas crack in a charged gas line can cause a leak at the stop application and can be particularly pernicious if the leak is not detected during installation and only develops later as the crack propagates into the pipe following installation.

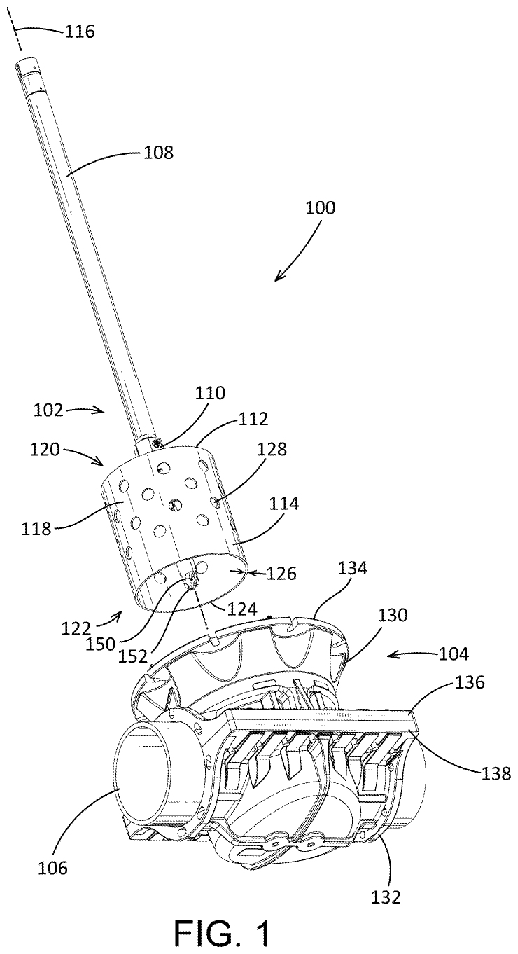

FIG. 1 shows an extraction tool 100 comprising a rotation tool assembly 102 and an encasing tool assembly 104 coupled to a pipe 106. The rotation tool assembly 102 comprises an elongated rod 108 coupled to a hub 110 that supports and/or is coupled to an endcap 112 of a shell cutter 114. Endcap 112 extends radially outward from a rotational axis 116 of rotation tool assembly 102 to a circular sidewall 118 of shell cutter 114. Shell cutter 114 can be supported by endcap 112 as rotation tool assembly 102 is rotated. As illustrated, a first or trailing end 120 of shell cutter 114 comprises endcap 112, and sidewall 118 extends from endcap 112 to a second or cutting end 122 of shell cutter 114. Teeth 124 on the lower end of shell cutter 114 generate a circular cut or kerf 126 into pipe 106 and facilitate the cutting, extraction, and/or removal of a coupon from pipe 106. One or more clearance holes 128 can extend through sidewall 118 of shell cutter 114. As shown in FIG. 1, sidewall 118 can include a plurality of clearance holes 128 to facilitate the removal of the coupon if it becomes stuck within shell cutter 114.

Encasing tool assembly 104, such as a tapping sleeve, surrounds a portion of pipe 106 and can seal the pipe 106 so that the penetration of shell cutter 114 is limited within a sealed area. For example, the fluid can be contained within encasing tool assembly 104 when the coupon is removed. Encasing tool assembly 104 can comprise an upper half or cover 130 and a lower half or cap 132 opposite cover 130 to completely surround and fluidly seal the working fluid in pipe 106 within extraction tool 100. Additional components can couple and fluidly seal to a sealing flange 134 of cover 130 to contain rotation tool assembly 102 within the sealed perimeter of extraction tool 100. In some aspects, the encasing tool assembly 104 can be assembled by coupling a cap flange 136 to a cover flange 138 to secure and fluidly seal encasing tool assembly 104 on/about pipe 106.

Rotation tool assembly 102 further comprises a pilot drill bit assembly 150 comprising cutting teeth 152 centrally located along rotational axis 116, and, in the position shown in FIG. 1, the cutting teeth 152 can be extended axially from the cutting end 122 of shell cutter 114. In various aspects, the drive mechanism can be either automated or manual. For example, the drive mechanism can rotate the tool in a manner analogous to a drill rotating a hole saw. In various aspects, the drive mechanism can be electronically coupled, e.g., over a network, and be controlled electronically such as automatically and/or remotely. In some aspects, the drive mechanism can be manual. For instance, an operator can turn a wheel or gear set to rotate the fitting.

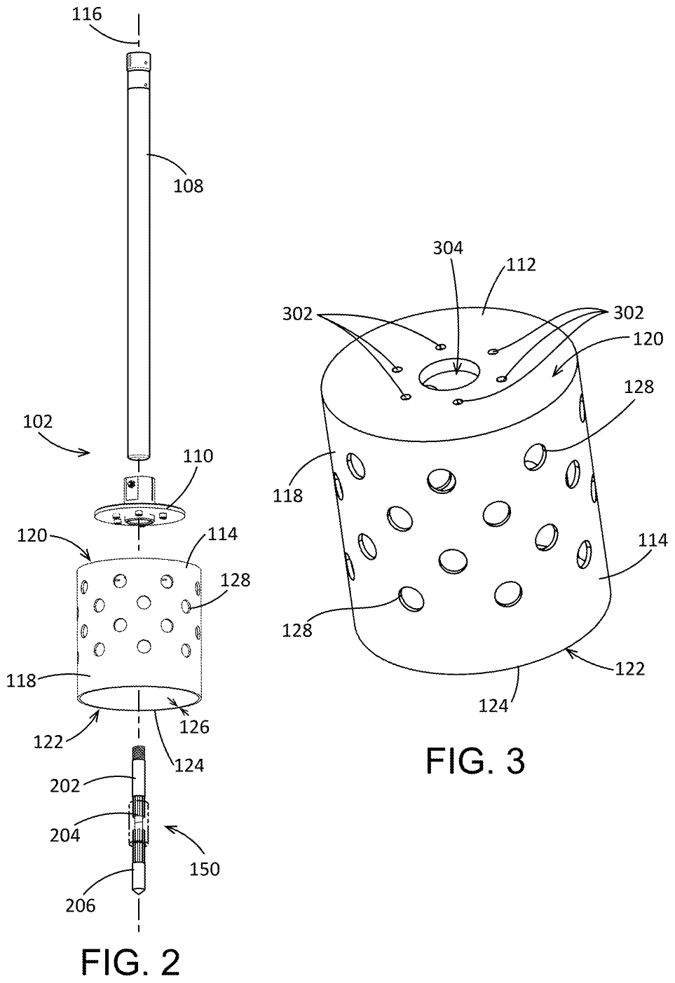

FIG. 2 is an exploded view of rotation tool assembly 102. Pilot drill bit assembly 150 comprises a stem 202, a collar 204, and a pilot drill bit, or bit 206. As described below, pilot drill bit assembly 150 supports bit 206 and can provide a rotational degree of freedom to bit 206 relative to stem 202 and collar 204 to permit bit 206 to align with stem 202 and axially retract bit 206 along rotational axis 116 within shell cutter 114. In various aspects, stem 202, collar 204, and/or bit 206 can comprise a high toughness steel, such as carbonized steel.

FIG. 3 is a perspective view of shell cutter 114. As shown in FIG. 3, the endcap 112 of shell cutter 114 comprises a plurality of fastener attachments or a fastener pattern 302 that connects hub 110 (FIG. 2) to endcap 112 of shell cutter 114. A connection bore 304, and fastener pattern 302 can cooperate to couple elongated rod 108 (FIG. 2) to shell cutter 114. The rotation of elongated rod 108 can facilitate the rotation of pilot drill bit assembly 150 (FIG. 2) comprising (and rotating) shell cutter 114 and/or pilot drill bit assembly 140 (FIG. 2). For example, elongated rod 108 can be rotated clockwise and thereby rotate hub 110, which supports both pilot drill bit assembly 150 (FIG. 2) and shell cutter 114. Bit 206 (FIG. 2) can penetrate pipe 106 (FIG. 1) first to orient the shell cutter 114 and maintain the shell cutter 114 orientation as it cuts through the coupon to reduce crack formations in pipe 106 (FIG. 1).

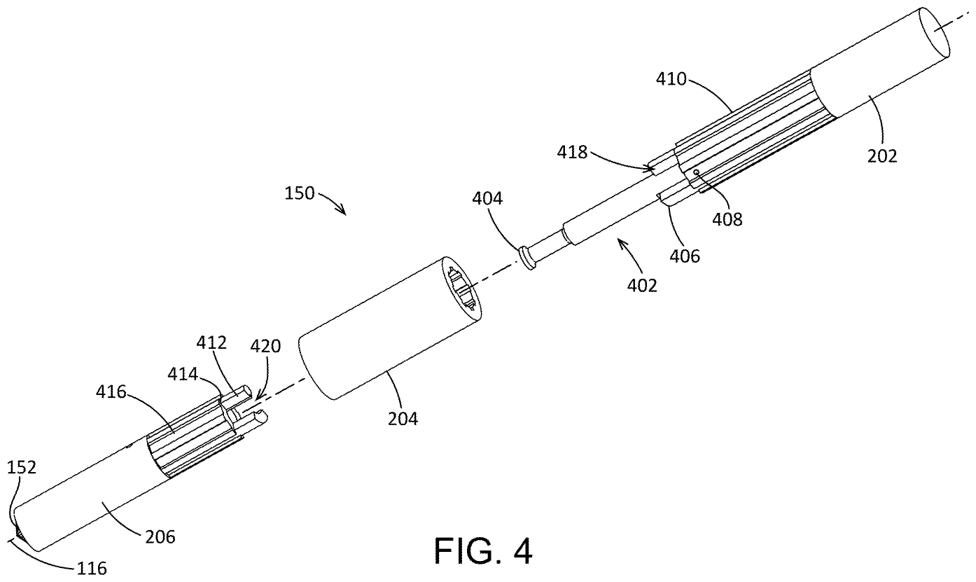

FIG. 4 is a perspective view of pilot drill bit assembly 150 comprising stem 202, collar 204, and bit 206 in an exploded view relative to rotational axis 116. Stem 202 comprises a projection 402 that terminates in a plug 404. Various splines 406 extend from recesses 408 and detents 410, which further extend axially along the circumferential sides of stem 202. The splines 406, recesses 408, and detents 410 of stem 202 are configured to correspond with similar structures of collar 204 and/or bit 206 to facilitate the freedom of rotation in the rotatable configuration of FIG. 10 and the freedom of translation in the retracted configuration of FIG. 11.

Collar 204 is configured to surround and/or align with recesses 408 and detents 410 of stem 202 to align a spline 412 of bit 206 with the spline 406 of stem 202 in a first configuration that stabilizes bit 206 in the cutting position. As the collar 204 is pushed away from bit 206, recesses 414 and detents 416 of bit 206 are released from collar 204 and spline 412 of bit 206 can rotate relative to spline 406 of stem 202. In other words, the recesses 414 and detents 416 can be configured to identify and/or align with the recesses 408 and detents 410 of stem 202 to change the rotational degree of freedom of bit 206 in the rotatable configuration to the translational degree of freedom. The translational degree of freedom can rotate to shorten the overall length of pilot drill bit assembly 150 axially, e.g., measured along rotational axis 116, into the retracted configuration 1102 (shown in FIG. 11). When spline 412 of bit 206 rotates into a pocket 418 of stem 202, spline 406 of stem 202 rotates into a pocket 420 of bit 206, and bit 206 is translated into the retracted configuration 1102 of FIG. 11.

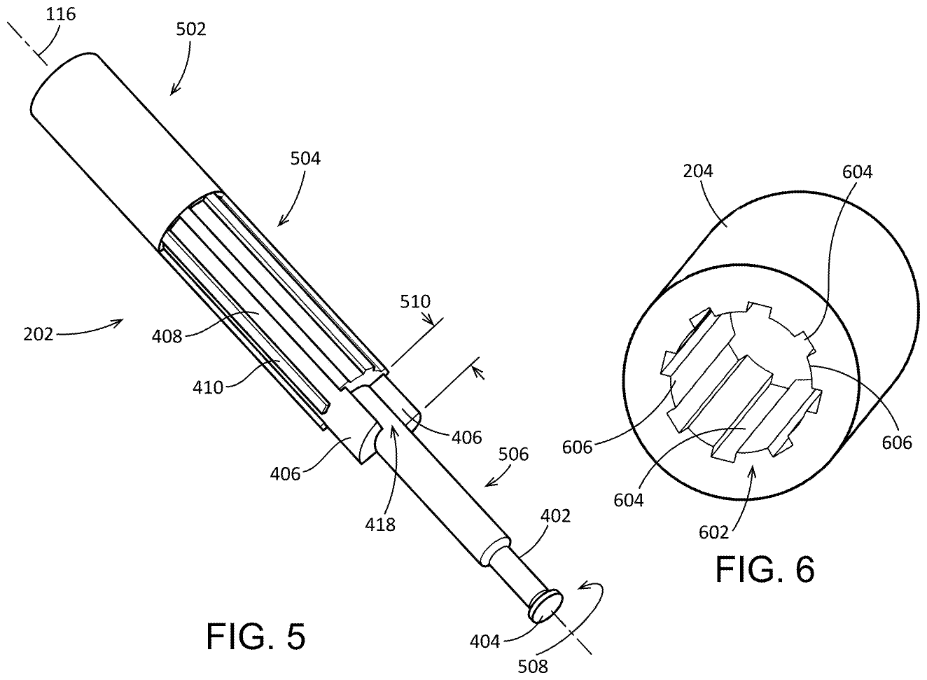

FIG. 5 is a perspective view of stem 202 illustrating a base portion 502, a key portion 504, and a translating portion 506. Base portion 502 is configured to couple stem 202 to hub 110 and/or endcap 112 (FIG. 1). Stem 202 is centrally located within endcap 112 of shell cutter 114 and extends along rotational axis 116 (FIG. 1). When a manual and/or automatic actuator rotates rotation tool assembly 102, elongated rod 108 rotates hub 110, and endcap 112 in a first rotational direction 508. For example, the first rotational direction can be a clockwise rotational direction (e.g., first rotational direction 508) about the rotational axis 116. Splines 406 of stem 202 define a translational depth 510 configured to receive spline 412 of bit 206 (FIG. 4) to retract bit 206 in the retracted configuration, e.g., of FIG. 16. As described later, the translational depth 510 of stem 202 can be roughly equal to the total retraction of bit 206 in the retracted configuration (FIG. 16). That is, the translational depth 510 of stem 202 is added to an analogous translational depth of bit 206, and the total retraction of bit 206 can be equal to half the sum.

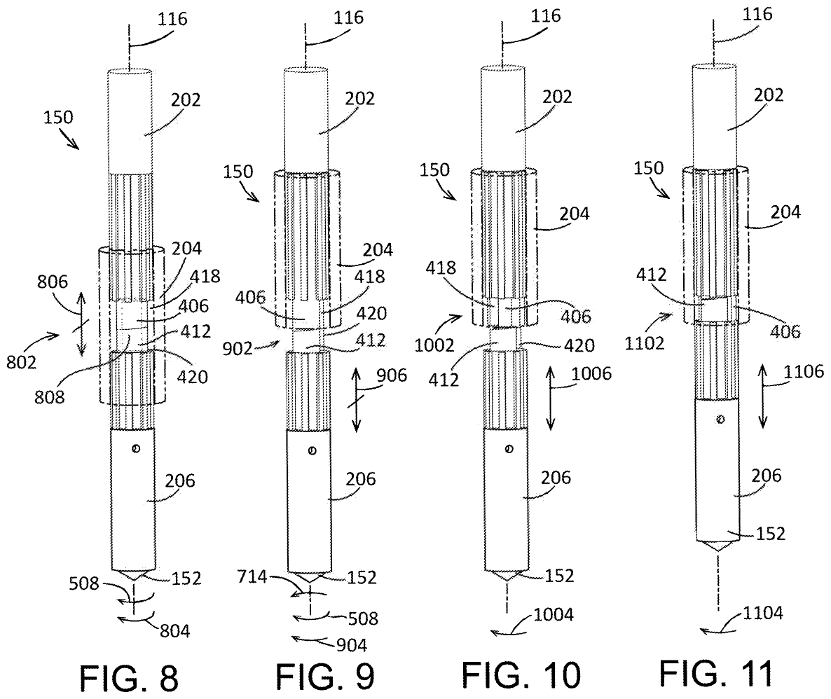

With reference to FIGS. 1, 2, and 5, key portion 504 is configured to align with collar 204 to restrain both a rotational degree of freedom and a translational degree of freedom of bit 206 in the penetration configuration of FIG. 8. Key portion 504 is translated axially along rotational axis 116 when bit 206 penetrates pipe 106 and collar 204 is pushed backward on the outer surface of pipe 106.

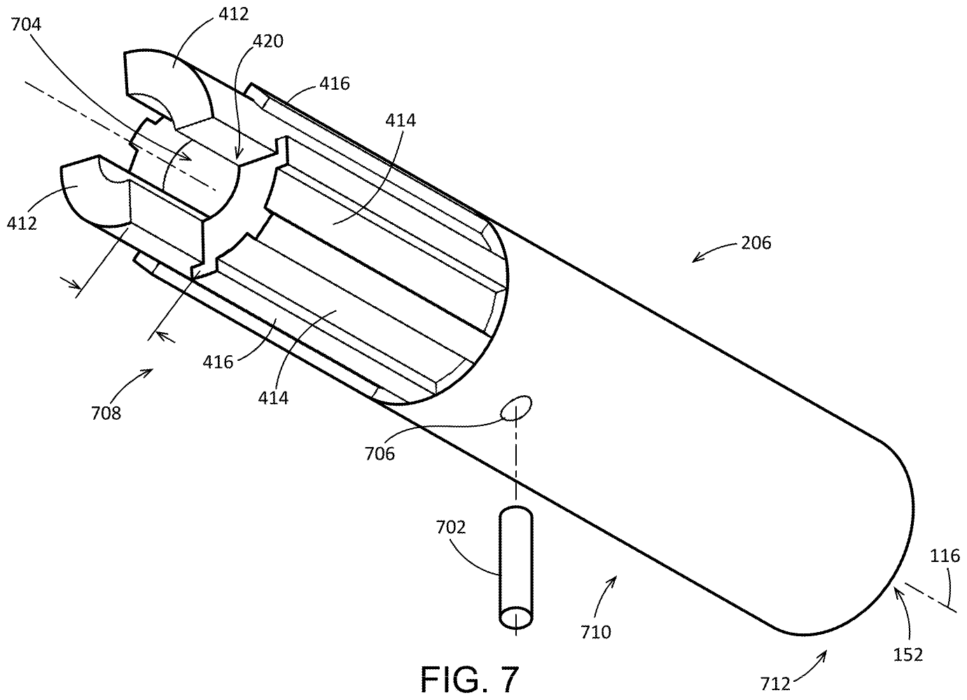

Returning to FIG. 5, translating portion 506 of stem 202 is configured to align stem 202 within bit 206 axially (e.g., within a bore 704 shown in FIG. 7). The translating portion 506 of stem 202 functions to ensure that stem 202 and bit 206 are linearly oriented and extend axially (e.g., along rotational axis 116). When bit 206 rotates and/or translates from a rotatable configuration (e.g., of FIG. 10) to the retracted configuration (e.g., of FIG. 11), translating portion 506 of stem 202 ensures that the stem 202 and bit 206 are axially and linearly oriented about rotational axis 116.

FIG. 6 is a perspective collar 204. Collar 204 comprises a key 602 comprising a plurality of inlets 604 and extensions 606 configured to restrain translational movement of collar 204 when bit 206 is in the penetrating configuration of FIG. 8. With reference to FIG. 4, the collar 204 can be keyed to translate axially along rotational axis 116 towards the base portion 502 when bit 206 is in the displaced and/or retracted configurations of FIGS. 9 and 10. That is, collar 204 comprises key 602 to prevent premature translation of collar 204 until collar 204 is rotated into a displaced configuration and pressure on bit 206 and/or collar 204 translates collar 204 axially from covering a portion of the translating portion 506 of stem 202 to key portion 504 of stem 202.

FIG. 7 is a perspective view of bit 206 comprising a fastening assembly 702 configured to capture projection 402 of stem 202 (FIG. 5) within bit 206 and secure the bit 206 to the stem 202. With reference to FIGS. 5 and 7, projection 402 of stem 202 is inserted into bore 704 of bit 206 and fastened with fastening assembly 702 extending through fastener hole 706 of bit 206. Bit 206 comprises a connection portion 708, an extension portion 710, and a cutting portion 712. Connection portion 708 is configured to interact with collar 204 and/or stem 202 (FIGS. 5-6) to restrain and/or limit the rotational and translational degrees of freedom of bit 206 in the penetrating configuration, permit rotation of bit 206 in the rotatable configuration, and permit translation of bit 206 in the translating position of FIG. 10. With reference to FIGS. 5-7, when inlets 604 and extensions 606 of key 602 on collar 204 align with recesses 414 and detents 416 of bit 206, rotation of pilot drill bit assembly 150 (FIG. 1) rotates bit 206 about rotational axis 116. Once collar 204 is translated off the bit 206, for example by pressure on the outer surface of pipe 106 (FIG. 1), the inlets 604 and extensions 606 of key 602 in collar 204 release recesses 414 and detents 416 of bit 206, and bit 206 can rotate in a second rotation direction 714 (e.g., counter-clockwise relative to rotational axis 116) opposite the first rotational direction 508 (FIG. 5). Stated differently, in the rotatable configuration (FIG. 9), bit 206 rotates about rotational axis 116 in the opposite direction (e.g., rotates at a different/slower speed or in the opposite rotational direction) relative to stem 202.

FIGS. 8-11 are perspectives of pilot drill bit assembly 150 rotating and translating from a first or penetrating configuration 802, shown in FIG. 8, to a retracted configuration 1102, shown in FIG. 11. Collar 204 is illustrated in transparency to highlight and show the interaction of stem 202 relative to bit 206. Specifically, when spline 412 of bit 206 rotates relative to spline 406 of stem 202, spline 412 translates into pocket 418 of stem 202, and spline 406 translates into pocket 420 of bit 206 to move into retracted configuration 1102. FIG. 8 shows bit 206 in the penetrating configuration 802. In the penetrating configuration 802, the rotational and translational degrees of freedom of bit 206 relative to stem 202 and/or collar 204 is restrained, such that bit 206 rotates in the first rotational direction 508 when the stem 202 and collar 204 are rotated in the first rotational direction 508.

In penetrating configuration 802, a rotational degree of freedom 804 is constrained. When stem 202 and/or collar 204 rotate in the first rotational direction 508, bit 206 is forced to rotate in the first rotational direction 508. Similarly, spline 406 of stem 202 rests against spline 412 of bit 206 to constrain the translational degree of freedom 806 and prevent movement in the axial direction of rotational axis 116. Spline 406 of stem 202 and spline 412 of bit 206 each comprise an angled wedge 808 that prevents rotation of spline 406 relative to spline 412. In other words, the angled wedge 808 prevents rotation of bit 206 relative to stem 202 until threshold friction on teeth 152 of bit 206 overcomes the fiction at angled wedge 808 or until collar 204 is pushed back over stem 202, such as when collar 204 is pressed against an outer surface of pipe 106.

FIG. 9 is a perspective view of pilot drill bit assembly 150 in a second or displaced configuration 902. As shown in FIG. 9, collar 204 can be pushed from over a portion of translating portion 506 to be captured within key portion 504 of stem 202. In this orientation, collar 204 does not interact with bit 206, and bit 206 is free to rotate relative to collar 204 and stem 202. Stated differently, a rotational degree of freedom 904 permits bit 206 to rotate in the second rotation direction 714 opposite the first rotational direction 508 of the stem 202 and collar 204. The translational degree of freedom 906 is constrained at angled wedge 808 as the splines 406 of stem 202 are pressing against the splines 412 of bit 206.

FIG. 10 is a perspective view of pilot drill bit assembly 150 in a third or rotatable configuration 1002, where bit 206 comprises an independent rotational degree of freedom 1004 from stem 202 and collar 204. As shown in FIG. 10, bit 206 is rotated relative to stem 202 such that an additional translational degree of freedom 1006 exists since the key 602 of collar 204 is removed from the recesses 414 and detents 416 of bit 206 and entirely on the recesses 408 and detents 410 of stem 202.

FIG. 11 is a perspective view of pilot drill bit assembly 150 in a fourth or retracted configuration 1102. In the retracted configuration, splines 406 of stem 202 are retracted into pockets 420 of bit 206. Similarly, splines 412 of bit 206 are retracted into pockets 418 of stem 202, and a rotational degree of freedom 1104 and a translational degree of freedom 1106 of bit 206 is constrained in the retracted configuration 1102. Further, teeth 152 of bit 206 are retracted nearer the trailing end 120 of shell cutter 114 than teeth 124 of the shell cutter 114. In other words, teeth 152 of bit 206 are not cutting into the second wall of pipe 106, and only teeth 124 of shell cutter 114 cut through the second end of pipe 106 and remove the coupon.

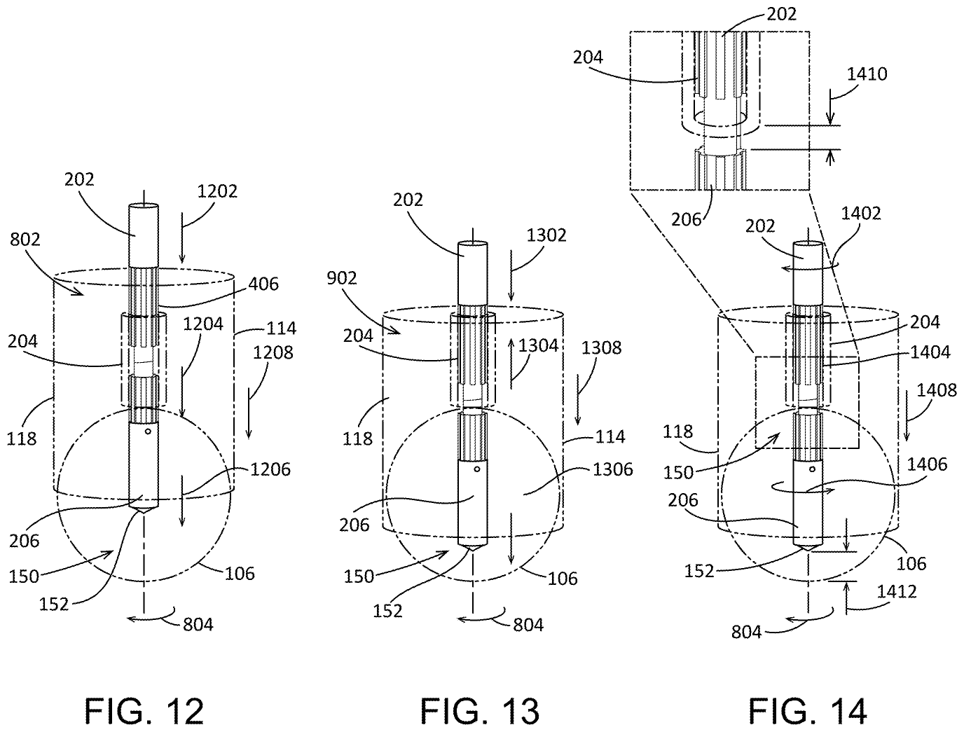

FIG. 12 is a schematic of shell cutter 114 and pilot drill bit assembly 150 in the penetrating configuration 802. Similar to FIGS. 8-11 illustrating changes in the pilot drill bit assembly 150 as it rotates and/or translates from the penetrating configuration 802 (FIG. 8) to the retracted configuration 1102 (FIG. 11), FIGS. 12-16 illustrate the changes in the pilot drill bit assembly 150 relative to the shell cutter 114. Specifically, FIG. 12 shows the pilot drill bit assembly 150 extending past the shell cutter 114 to penetrate pipe 106 and provide stability to shell cutter 114. Once collar 204 of pilot drill bit assembly 150 reaches the outer surface of pipe 106, pipe 106 restrains the translational movement of collar 204 relative to pilot drill bit assembly 150 on pipe 106. Stated differently, in the penetrating configuration 802 stem 202 can translate or more the same translational movement as collar 204 and bit 206. That is, stem translational movement 1202, collar translational movement 1204, and bit translational movement 1206 are all aligned, equal, and oriented in the same direction. Also, shell cutter translational movement 1208 is aligned with and equal to the translational movements of stem 202, collar 204, and bit 206 because the rotational degree of freedom 804 of the pilot drill bit assembly 150 is restrained, and the pilot drill bit assembly 150 functions to assist and orient sidewall 118 of shell cutter 114 and collectively pilot drill bit assembly 150 and shell cutter 114 penetrate the pipe 106 as if it were a single unitary body.

FIG. 13 is a schematic representation of the shell cutter 114 and the pilot drill bit assembly 150 in the displaced configuration 902. That is, once collar 204 is pressed against an outer wall of pipe 106, collar 204 begins to slide up stem 202 since the recesses 408 and detents 410 (FIG. 4) of stem 202 are already aligned with the inlets 604 and extensions 606 (FIG. 6) of collar 204. FIG. 13 illustrates that stem translational movement 1302 is now opposite collar axial translation 1304 since collar 204 can begin axial translation 1304 due to the outer surface of pipe 106 forcing collar 204 up stem 202. Similarly, bit 206 extends axially away from collar 204 along bit translational movement 1306. That is, bit translational movement 1306 and stem translational movement 1302 are opposite from collar axial translation 1304. In this way, collar 204 transforms and translates up/off of bit 206. Shell cutter translational movement 1308 remains unchanged and continues to follow the stem translational movement 1302 and the bit translational movement 1306.

The pilot drill bit assembly 150 is transforming to create a rotational degree of freedom 804, described in FIG. 14. Once collar 204 experiences enough axial translation 1304 movement to free the inlets 604 and/or extensions 606 (FIG. 6) of collar 204 from the recesses 414 and detents 416 of bit 206, the spline 412 of bit 206 (and bit 206) is free to rotate independent of collar 204 and/or stem 202. The independent rotation of bit 206 relative to collar 204 and/or stem 202 moves pilot drill bit assembly 150 into the rotatable configuration 1002 of FIG. 14.

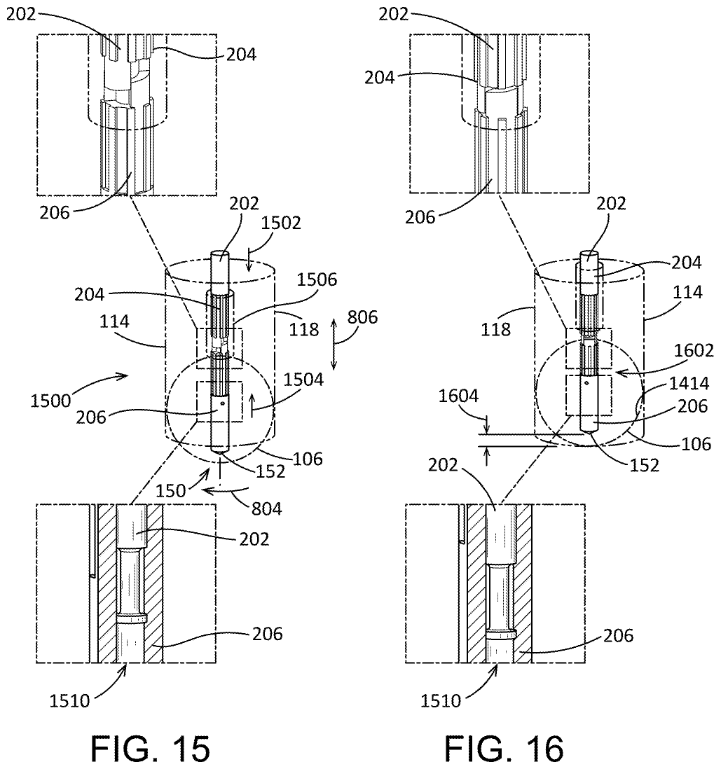

FIG. 14 is a schematic representation of the shell cutter 114 and pilot drill bit assembly 150 in the rotatable configuration 1002. In the rotatable configuration 1002, bit 206 comprises a rotational degree of freedom 804, enabling bit 206 to rotate independent from collar 204 and/or stem 202. As illustrated in FIG. 14, the stem 202 is rotated in a first direction 1402 (e.g., clockwise), and the collar 204 is held in a state of translational freedom 1404 to permit bit 206 to rotate in a second direction 1406 opposite the first direction 1402 of rotation in the stem 202 and collar 204. Shell cutter 114 continues to move along translation direction 1408 and cut/remove pipe 106. A rotational gap 1410 is created between collar 204 and bit 206 to facilitate translational freedom 1404 of the bit 206 relative to the stem 202 and collar 204 of pilot drill bit assembly 150. A translational gap 1412 can exist between bit 206 and an inner pipe surface 1414 of pipe 106. As translational gap 1412 goes to zero, and bit 206 is forced against inner pipe surface 1414, the translational freedom 1404 will allow bit 206 to translate upwards, as illustrated in FIG. 15.

FIG. 15 is a schematic representation of the shell cutter 114 and pilot drill bit assembly 150 before retraction in an alignment configuration 1500. The rotational degree of freedom 804 is converted into an axial translational degree of freedom 806. Stem translational direction 1502 is opposite bit translational direction 1504. In the retractable configuration 1506, stem 204 and bit 206 are aligned in such a way as to lock the bit 206 rotationally relative to the stem 204, but permit bit 206 to slide along the bit translational direction 1504. In this way, the overall length of the stem 204 and bit 206 is shortened. Specifically, bit 206 is pushed back to close the translational depth 510 (FIG. 5). When spline 412 of bit 206 is aligned into pocket 418 of stem 202, spline 406 of stem 202 and spline 412 of bit 206 reduce the overall length of pilot drill bit assembly 150 by translational depth 510 (FIG. 5), and the pilot drill bit assembly 150 moves into a locked configuration (e.g., as shown in FIG. 16).

Translational alignment is maintained by projection 402 and plug 404 moving within bore 704 to keep bit 206 axially aligned stem 202 as the length of pilot drill bit assembly 150 is decreased by translational depth 510. (FIG. 5). This movement creates a gap 1510 between bit 206 and inner pipe surface 1414. In various aspects, bit 206 is retracted behind shell cutter 114 so that bit 206 does not penetrate pipe 106 while shell cutter 114 removes the pipe coupon, for example, to entirely separate pipe 106.

FIG. 16 is a schematic representation of the shell cutter 114 and pilot drill bit assembly 150 in the retracted configuration 1602. The shell cutter 114 is fully extended through pipe 106, and pilot drill bit assembly 150 is not penetrating inner pipe surface 1414. Stated differently, there is a gap 1604 where bit 206 trails behind shell cutter 114. In some aspects, translational alignment 1508 is at a minimum so that the totality of translational depth 510 (FIG. 5) is utilized to retract pilot drill bit assembly 150 from inner pipe surface 1414 and/or pipe 106.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A retractable pilot bit comprising:
a stem defining a rotational axis and configured to rotate in a first rotational direction about the rotational axis;
a collar coupled to the stem and configured to rotate in the first rotational direction; and
a bit, configured to rotate in the first rotational direction in a penetrating configuration and configured to rotate in a second rotational direction opposite the first rotational direction in a rotatable configuration.

2. The retractable pilot bit of claim 1, further comprising a spline on the stem that is complimentary to and opposite from a spline on the bit.

3. The retractable pilot bit of claim 2, wherein the spline on the stem defines a first angled wedge that is complimentary to a second angled wedge on the bit, and wherein the first angled wedge rotates the second angled wedge when the bit is in the penetrating configuration.

4. The retractable pilot bit of claim 1, wherein the stem comprises recess and detents that are keyed and configured to receive extensions and inlets of the collar, respectively.

5. The retractable pilot bit of claim 4, wherein when the collar moves onto a key portion of the stem, the extensions and inlets of the collar are moved over recesses and detents of the bit, such that the bit is free from the collar and defines an independent rotational degree of freedom relative to the stem and the collar.

6. The retractable pilot bit of claim 1, wherein the stem further comprises a translating portion that is configured to move within a bore of the bit, in the penetrating configuration, the translating portion extends within the bore of the bit and in a retracted configuration the translating portion is translated within the bore nearer to cutting teeth of the bit.

7. The retractable pilot bit of claim 1, wherein in the penetrating configuration, splines of the stem form an angled wedge with splines of the bit, and in a retracted configuration, splines of the stem are disposed within pockets of the bit, and splines of the bit are disposed within pockets of the stem.

8. The retractable pilot bit of claim 1, wherein the bit is a first bit and further comprising a second bit, wherein the stem and the collar are configured to remove the first bit and rotate the second bit in the first rotational direction in the penetrating configuration and the second rotational direction opposite the first rotational direction in the rotatable configuration.

9. The retractable pilot bit of claim 1, wherein the stem, the collar, and the bit comprise carbonized steel.

10. A rotation tool assembly comprising:
a hub;
a shell cutter comprising a sidewall and an endcap coupled to the hub; and
a pilot bit assembly comprising:
a stem defining a rotational axis and configured to rotate in a first rotational direction about the rotational axis;
a collar coupled to the stem and configured to rotate in the first rotational direction; and
a bit, configured to rotate in the first rotational direction in a penetrating configuration and configured to rotate in a second rotational direction opposite the first rotational direction in a rotatable configuration.

11. The rotation tool assembly of claim 10, wherein in the penetrating configuration, the bit extends past the shell cutter.

12. The rotation tool assembly of claim 10, wherein when the bit is rotated in the second rotational direction, the bit is retracted into a retracted configuration where the shell cutter extends past the bit.

13. The rotation tool assembly of claim 10, wherein a sidewall diameter is greater than a pipe diameter such that a coupon is completely removed from a pipe.

14. The rotation tool assembly of claim 10, wherein the stem further comprises a spline defining a stem translational depth and the bit further comprises a spline defining a bit translational depth, and wherein when the spline of the bit is rotated relative to the spline of the stem, the bit translates one of either the stem translational depth or the bit translational depth in an axial direction.

15. The rotation tool assembly of claim 14, wherein the bit translational depth is equal to the stem translational depth, and the bit translates in the axial direction the bit translational depth.

16. The rotation tool assembly of claim 14, wherein the spline of the bit comprises an angled wedge and the spline of the stem comprises an angled wedge, wherein the angled wedge of the bit and the angled wedge of the stem prevent the bit from rotating relative to the stem until some frictional force is applied to the bit.

17. A method comprising:
engaging a pilot bit on an outer wall of a pipe to guide a sidewall of a shell cutter to cut a top portion of the pipe;
retracting the pilot bit prior to the pilot bit engaging an inner wall of the pipe; and
cutting through the inner wall of the pipe with the sidewall of the shell cutter such that the pilot bit engages the outer wall of the pipe but does not engage the inner wall of the pipe.

18. The method of claim 17, wherein a collar of the pilot bit engages the outer wall of the pipe to retract the pilot bit.

19. The method of claim 17, wherein the pilot bit comprises a stem and a bit and the stem rotates in a first direction, and the bit rotates in an opposite direction relative to the stem.

20. The method of claim 19, wherein the bit moves a translational depth of the stem.
